(19) United States
(12) Patent Application Publication
(10) Pub. No.: US 2018/0343814 A1
(43) Pub. Date: Dec. 6, 2018

(54) A METHOD AND APPARATUS FOR THE MANUFACTURE OF A WATER-ABSORBING PAD FOR PLANT CULTIVATION

(71) Applicant: Peter Hubertus Elisabeth ENDE, VAN DEN, Heerlen (NL)

(72) Inventor: Peter Hubertus Elisabeth ENDE, VAN DEN, Heerlen (NL)

(21) Appl. No.: 15/778,238

(22) PCT Filed: Nov. 28, 2016
(86) PCT No.: PCT/NL2016/050838

§ 371 Date: May 23, 2018

(30) Foreign Application Priority Data
Nov. 26, 2015 (NL) 2015862
Nov. 26, 2015 (NL) 2015863

(51) Int. Cl. A01G 27/00; A01G 24/35

(52) U.S. Cl. CPC A01G 27/006; A01G 27/008; A01G 24/35

(57) ABSTRACT

In a method for the manufacture of a pad built up from two fluid permeable, flexible sheets attached to each other with moisturizing, swellable gel in between, the sheets are supplied as pre-cut sheets and a first sheet of the pre-cut sheets is placed on a transport plate. Then, a layer of glue is applied on an upwardly facing side of the first sheet. Thereafter, gel beads are or gel powder is evenly applied on the upwardly facing side of the first sheet. Then, a second one of the pre-cut sheets is applied to the gel and the adhesive layer. Then a heated heating plate is pressed for some time on the top sheet of the pad formed this way.

### TECHNICAL FIELD OF THE INVENTION

The invention relates to a method for the manufacture of a pad comprising two fluid permeable, flexible sheets attached to each other and moisturizing, swellable gel in between, said method comprising attaching the sheets to each, whereby it is ensured that gel and adhesive will be between them, and drying the glue.

In the process for the manufacture of the pad, the sheets are attached to one another whereby it is ensured that adhesive and gel is between the sheets. Then the adhesive is dried. The sheets can be pre or post-tailored.

The device for producing a pad comprising two fluid permeable, flexible sheets attached to each other and moisturizing, swellable gel in between, comprising:
feed means for feeding a first one of the said sheets,
transport means for transporting the first sheet through the device,
gluing means for applying an adhesive layer on one side of the first sheet,
strewing means for strewing of the gel on said side of the first sheet,
further feed means for feeding and applying a second of the said sheets on the layer of adhesive and the gel, and
drying means for drying of the adhesive.

### BACKGROUND OF THE INVENTION

Such a method and device are generally known.

### SUMMARY OF THE INVENTION

It is an object of the present invention to provide a device of the type defined in the opening paragraph with which a pad can be manufactured in an economically favorable manner (quickly and inexpensively with little energy). To this end the method according to the invention is characterized in that:
first a first sheet of the sheets is placed on a transport plate,
then a layer of the adhesive is provided on an upwardly facing side of the first sheet,
then gel powder or gel granules evenly distributed is/are applied to the upwardly facing side of the first sheet,
then a second sheet of the sheets is applied on the gel and the adhesive layer, and
subsequently a heated heating plate is pressed on the upper sheet for some time.

The latter prevents the pad from creasing or warping during drying.

Preferably, the first sheet of the pad to be manufactured is of paper and the second sheet is of jute. A favorable embodiment of the method for the manufacture of such a pad is characterized in that after the application of the second pre-cut sheet and before pressing the heating plate, the two sheets with the gel powder or gel granules in between are turned upside down.

The sheets can be supplied from a roll, whereby after heating, the sheets are cut tailor-made and the cut parts constitute the pads. The sheets can also be provided as separate pre-cut sheets.

In order to improve the adhesion of the layer of jute to the first sheet which is provided with gel beads or gel powder an embodiment of the method according to the invention, is characterized in that, after the application of the gel powder or gel beads and before the application of the second sheet, a second layer of glue is applied on the upwardly facing side of the first sheet on which the gel beads or gel powder is present.

A favorable embodiment of the method according to the invention is characterized in that, after pressing a heated heating plate on the top sheet for some time, the heating plate is taken from the pad and the pad is exposed to the surroundings for some time and then again the heated heating plate, or a further heated heating plate, is pressed for a certain time on the top sheet of the pad formed this way. Thus, between the periods of heating the resulting vapor can escape by which the drying process is accelerated.

In order to accelerate the drying process even more, a further advantageous embodiment of the method according to the invention is characterized in that a perforated transport plate is used and during the pressing of the heated heating plate on the pad vapor resulting from the heating is sucked off through the openings in the transport plate.

In order to acceleration the drying process even further, an embodiment of the method according to the invention is characterized in that a perforated heating plate is used and during the pressing of the heated heating plate on the pad the vapor resulting from the heating is sucked off through the openings in the heating plate.

Yet a further advantageous embodiment of the method according to the invention, is characterized in that, after the drying of the pad, smaller pads are cut or punched from the pad.

Regarding the device, the invention is characterized in that the drying means comprise a flat heating plate and pressing means which press the heating plate on the upper sheet for some time.

A favorable embodiment of the device according to the invention is characterized in that the drying means comprise at least one further flat heating plate and further pressing means which press the further heating plate on the second sheet for some time, in which the further heating plate and the further pressing means are at a distance one behind the other in the direction of transport.

A further favorable embodiment of the device according to the invention is characterized in that the transport means comprise a perforated transport plate on which the first sheet is present during presence in the device.

Yet further favorable embodiment of the device according to the invention is characterized in that the drying means comprise suction means which are present under the heating plate at the underside of the transport plate for the suction of vapor produced in the heating operation.

Preferably, the heating plate is perforated and preferably the drying means further comprise suction means that are present above the heating plate for the suction of vapor produced in the heating operation.

In order to prevent the top sheet from adhering to the heating plate, the side of the heating plate which comes into contact with the top sheet is provided with an anti-adhesive layer, for example a cloth.

The gel beads are or gel powder is preferably glued to a sheet of paper and a sheet of jute is provided on top of that. To reduce the risk of adhering of the layer of jute with the gel and glue in it to the heating means the device preferably comprises turning means to turn the sheets with in between the gel powder or gel beads upside down.

In order to accelerate the drying process, the drying means preferably comprise a further flat heating plate, and further pressing means which press the further heating plate on the upper sheet for some time.

Preferably, the device further comprises cutting or die-cutting means for cutting or punching smaller pads from the pad after the drying of the pad.

A further object of the invention is to provide a device in which less gel is lost as waste. To this end, the device according to the invention is characterized in that the transport means
a conveyor belt, as well as
drive means which during operation continuously drive the conveyor belt, and
a transport plate which is present on the conveyor belt and during operation is moved by the conveyor belt through the device, on which transport plate the first sheet is present,
   and in that the strewing means comprise:
a template present above the conveyor belt, as well as
a strew bin present above the template, and
displacing means for displacing the template and the strew bin relative to one another in the direction of movement of conveyor belt.

A favorable embodiment of the device according to the invention is characterized in that the template is stationary and the strew bin is displaceable in a direction parallel to the direction of movement of the conveyor belt and that the device further comprises a stopper which during strewing stops the transport plate at a location directly below the template while the conveyor belt below the conveyor plate keeps running.

Another favorable embodiment of the device according to the invention is characterized in that the strew bin is stationary and the template is movable and that the device includes a catch pin that is attached to the template, and during use comes into contact with the transport plate so that the transport plate displaces the template under the strew bin.

A further favorable embodiment of the device according to the invention is characterized in that the template is formed by a tray provided with openings and having a raised peripheral edge and raised edges around the openings.

### BRIEF DESCRIPTION OF THE DRAWINGS

The invention will be further elucidated below on the basis of drawings.

These drawings show an embodiment of the device according to the present invention. In the drawings:

FIG. 1 is a schematic representation of the device in side elevation;

FIG. 2 is a schematic representation of the device in plan view; and

FIG. 3 is a schematic representation of the device in cross-section.

### DETAILED DESCRIPTION OF THE DRAWINGS

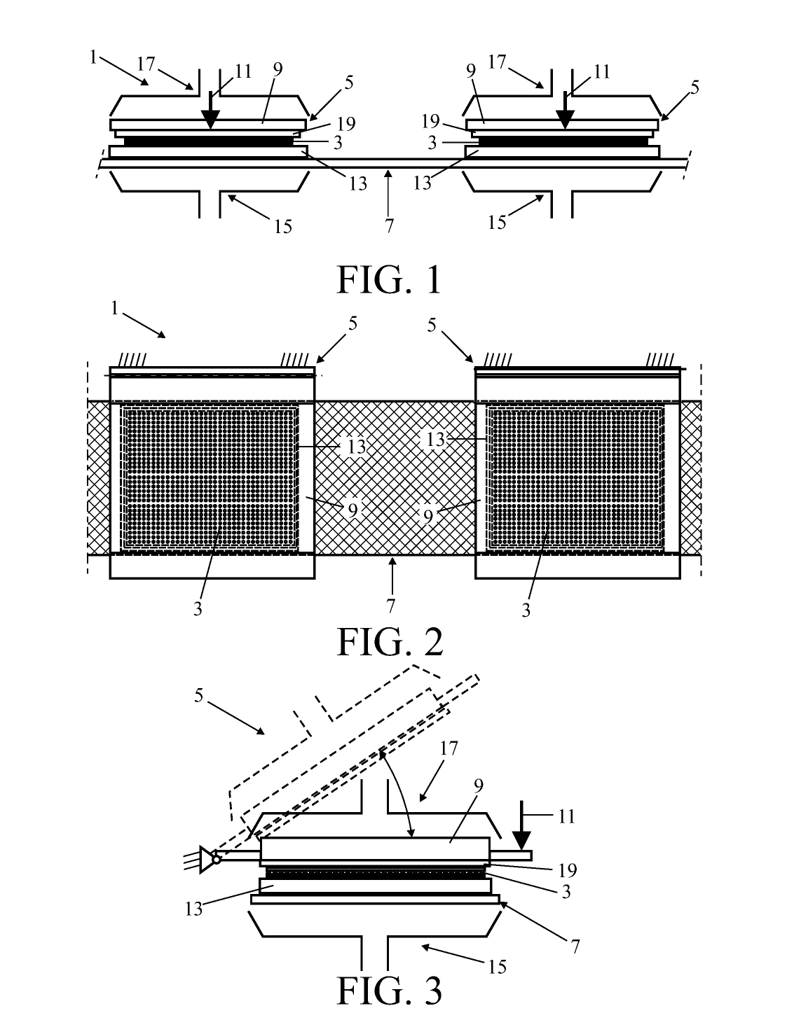

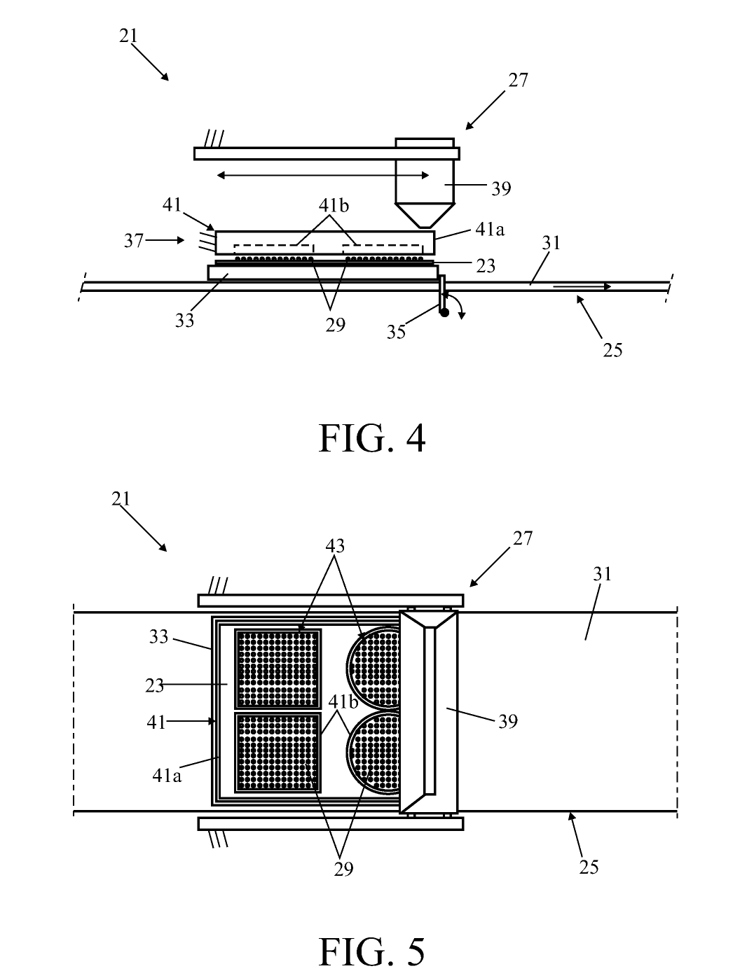

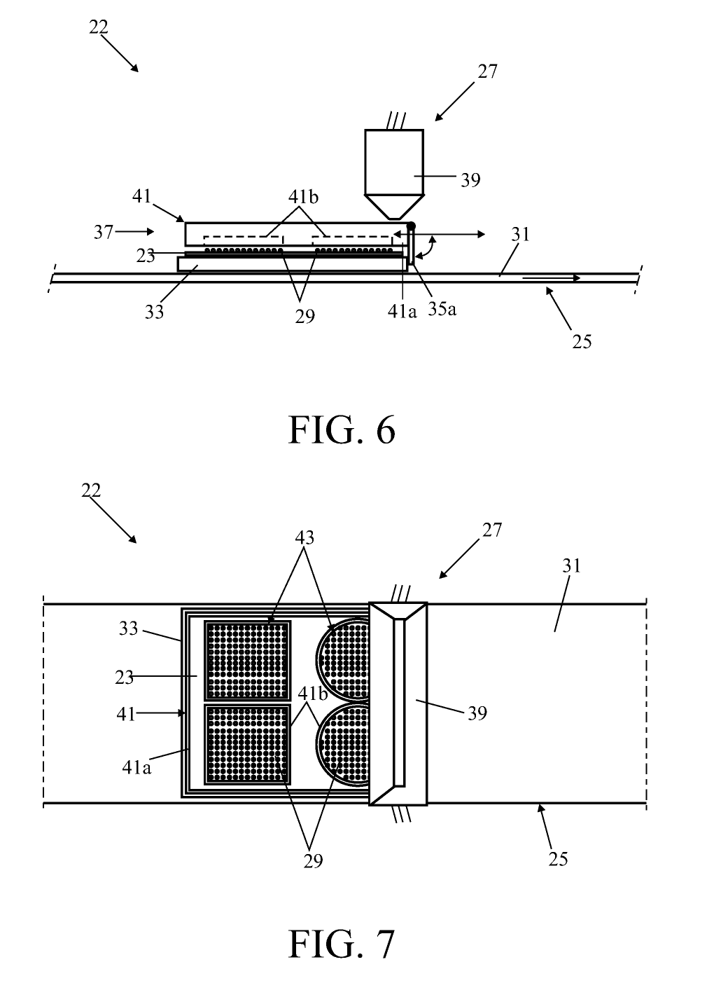

In the FIGS. 1-3 a first embodiment of the device 1 for producing pads 3 is shown. These pads are made up of two fluid permeable, flexible sheets attached to each other with moisturizing, swellable gel in between. The device has:
feed means (not shown) for feeding a first one of the said sheets,
transport means 7 for transporting the first sheet through the device,
gluing means (not shown) for applying an adhesive layer on one side of the first sheet,
strewing means (not shown) for strewing of the gel on said side of the first sheet,
further feed means (not shown) for feeding and applying a second of the said sheets on the layer of adhesive and the gel, and
the means 5 for drying of the adhesive.

The drying means 5 have a plurality of perforated, planar heating plates 9, as well as pressure means 11 (shown diagrammatically by an arrow) which press the heating plates for some time to the jute top sheet of the pads 3. In order to prevent the pads from adhering to the heating plates, the heating plates are provided with an anti-adhesion layer 19. This layer is for example formed by a cloth.

The conveying means have perforated transport plates 13 on which the paper sheet is present during residence in the device.

The drying means further have suction means 15 and 17 which are present under the heating plates at the underside of the transport plate and above the heating plates for the extraction of vapor during heating.

Furthermore, the device has cutting or punching means (not shown) in order to cut or punch smaller pads from the pad after the drying of the pad.

In FIGS. 4 and 5, a second embodiment of the device according to the invention is shown for producing a pad which is made up of two fluid permeable, flexible sheets attached to each other with moisturizing, swellable gel between them. The device 21 has feed means (not shown) for feeding of the first sheets 23. These sheets are made of paper. Further, the device has transport means 25 for conveying the paper sheet through the device. The device further has adhesive means (not shown) for applying a glue layer on the top side of the paper sheet. Furthermore, there are strewing means 27 for the strewing of gel 29 on the upper side of the paper sheet which upper side is provided with a layer of glue, and further adhesive means (not shown) for applying a second layer of adhesive on the gel and on the first adhesive layer.

Furthermore, the device has further feed means (not shown) for feeding and applying a second sheet of jute on the adhesive layer and on the gel. Furthermore, the device has drying means (not shown) for the drying of the glue, and cutting or die-cutting means (not shown) for cutting out or punching of smaller pads of the pad.

The transport means 27 are formed by a conveyor belt 31 and by drive means (not shown) which continuously drive the conveyor belt during operation. The transport means further include a number of transport plates 33 which are present on the conveyor belt and are moved through the device by the conveyor belt during operation. Paper sheets are present on the transport plates.

A stopper 35 holds the transport plate during strewing, while the conveyor belt continues to move under the transport plate. The strewing means 27 have a template 37 which is stationary above the transport plate and which is present above a position of the transport plate held by the stopper, as well as a strew bin 39 displaceable over the template. The template 37 is formed by a tray 41 provided with apertures 43 and having an upstanding peripheral edge 41a and having raised edges 41b around the openings.

In FIGS. 6 and 7 a third embodiment of the device according to the invention is shown. All parts that are equal to those of the second embodiment described above are indicated by the same reference numerals. In this device the stopper 22 is replaced by a catch pin 35a which is attached to the tray 41. The strew bin 39 is stationary connected to the fixed world and the tray 41 together with the transport plate 33 moves under the strew bin 39 during strewing. After the transport plate has been moved all the way underneath the strew bin, the catch pin flips over and the tray 41 is moved back to the initial position, this is the position shown in FIGS. 6 and 7.

Although the present invention is elucidated above on the basis of the given drawings, it should be noted that this invention is not limited whatsoever to the embodiments shown in the drawings. The invention also extends to all embodiments deviating from the embodiments shown in the drawings within the context defined by the claims.

1. A method for the manufacture of a pad comprising two fluid permeable, flexible sheets attached to each other and moisturizing, swellable gel in between, said method comprising attaching the sheets to each, whereby it is ensured that gel and adhesive will be between them, and drying the glue, characterized in that:
first a first sheet of the sheets is placed on a transport plate,
then a layer of the adhesive is provided on an upwardly facing side of the first sheet,
then gel powder or gel granules evenly distributed is/are applied to the upwardly facing side of the first sheet,
then a second sheet of the sheets is applied on the gel and the adhesive layer, and
subsequently a heated heating plate is pressed on the upper sheet for some time.

2. A method according to claim 1, characterized in that after the application of the second pre-cut sheet and before pressing the heating plate, the two sheets with the gel powder or gel granules in between are turned upside down, wherein the first sheet is of paper and the second sheet is of jute.

3. A method according to claim 1, characterized in that the sheets are supplied from a roll.

4. A method according to claim 3, characterized in that after heating, the sheets are cut tailor-made and the cut parts constitute the pads.

5. A method as claimed in claim 1 or 2, characterized in that the sheets are provided as separate pre-cut sheets.

6. A method according to claim 1, characterized in that, after the application of the gel powder or gel beads and before the application of the second sheet, a second layer of glue is applied on the upwardly facing side of the first sheet on which the gel beads or gel powder is present.

7. A method according to claim 1, characterized in that, after pressing a heated heating plate on the top sheet for some time, the heating plate is taken from the pad and the pad is exposed to the surroundings for some time and then again the heated heating plate, or a further heated heating plate, is pressed for a certain time on the top sheet of the pad formed this way.

8. A method according to claim 1, characterized in that a perforated transport plate is used and during the pressing of the heated heating plate on the pad vapor resulting from the heating is sucked off through the openings in the transport plate.

9. A method according to claim 1, characterized in that a perforated heating plate is used and during the pressing of the heated heating plate on the pad the vapor resulting from the heating is sucked off through the openings in the heating plate.

10. A method according to claim 1, characterized in that, after the drying of the pad, smaller pads are cut or punched from the pad.

11. A device for producing a pad comprising two fluid permeable, flexible sheets attached to each other and moisturizing, swellable gel in between, comprising:
feed means for feeding a first one of the said sheets,
transport means for transporting the first sheet through the device,
gluing means for applying an adhesive layer on one side of the first sheet,
strewing means for strewing of the gel on said side of the first sheet,
further feed means for feeding and applying a second of the said sheets on the layer of adhesive and the gel, and
drying means for drying of the adhesive,
characterized in that the drying means comprise a flat heating plate and pressing means which press the heating plate on the upper sheet for some time.

12. A device according to claim 11, characterized in that the drying means comprise at least one further flat heating plate and further pressing means which press the further heating plate on the second sheet for some time, in which the further heating plate and the further pressing means are at a distance one behind the other in the direction of transport.

13. Device according to claim 11, characterized in that the transport means comprise a perforated transport plate on which the first sheet is present during presence in the device.

14. A device according to claim 13, characterized in that the drying means comprise suction means which are present under the heating plate at the underside of the transport plate for the suction of vapor produced in the heating operation.

15. A device as claimed in claim 11, characterized in that the heating plate is perforated.

16. A device according to claim 15, characterized in that the drying means further comprise suction means that are present above the heating plate for the suction of vapor produced in the heating operation.

17. A device according to claim 11, characterized in that the side of the heating plate which comes into contact with the top sheet is provided with an anti-adhesive layer.

18. A device according to claim 11, characterized in that the device comprises turning means to turn the sheets with in between the gel powder or gel beads upside down.

9. A device according to claim 11, characterized in that the drying means comprise a further flat heating plate, and further pressing means which press the further heating plate on the upper sheet for some time.

20. A device according to claim 11, characterized in that the device comprises cutting or die-cutting means for cutting or punching smaller pads from the pad after the drying of the pad.

21. A device for producing a pad comprising two fluid permeable, flexible sheets attached to each other and moisturizing, swellable gel in between, comprising:
feed means for feeding a first one of the said sheets,
transport means for transporting the first sheet through the device,
gluing means for applying an adhesive layer on one side of the first sheet,
strewing means for strewing of the gel on said side of the first sheet,
further feed means for feeding and applying a second of the said sheets on the layer of adhesive and the gel, and
drying means for drying of the adhesive,
cutting or die-cutting means for cutting or punching of smaller pads out of the pad, characterized in that the transport means comprise:
a conveyor belt, as well as
drive means which during operation continuously drive the conveyor belt, and
a transport plate which is present on the conveyor belt and during operation is moved by the conveyor belt through the device, on which transport plate the first sheet is present,
and in that the strewing means comprise:
a template present above the conveyor belt, as well as
a strew bin present above the template, and
displacing means for displacing the template and the strew bin relative to one another in the direction of movement of conveyor belt.

22. A device according to claim 21, characterized in that the template is stationary and the strew bin is displaceable in a direction parallel to the direction of movement of the conveyor belt and that the device further comprises a stopper which during strewing stops the transport plate at a location directly below the template while the conveyor belt below the conveyor plate keeps running.

23. Device according to claim 21, characterized in that the strew bin is stationary and the template is movable and that the device includes a catch pin that is attached to the template, and during use comes into contact with the transport plate so that the transport plate displaces the template under the strew bin.

24. A device according to any one of the preceding claims, characterized in that the template is formed by a tray provided with openings and having a raised peripheral edge and raised edges around the openings.
